(19) United States
(12) Patent Application Publication
(10) Pub. No.: US 2022/0128756 A1
(43) Pub. Date: Apr. 28, 2022

(54) DISPLAY SYSTEM FOR GENERATING THREE-DIMENSIONAL IMAGE AND METHOD THEREFOR

(71) Applicant: Lightspace Technologies, SIA, Marupes novads (LV)

(72) Inventors: Ilmars Osmanis, Marupe (LV); Martins Narels, Riga (LV); Kriss Osmanis, Babites nov. (LV); Ainars Ozols, Siguldas pagasts (LV); Ugis Gertners, Riga (LV); Roberts Zabels, Riga (LV)

(73) Assignee: Lightspace Technologies, SIA, Marupes novads (LV)

(21) Appl. No.: 17/081,183

(22) Filed: Oct. 27, 2020

(51) Int. Cl. F21V 8/00; G02B 30/52; G02B 27/01; G09G 3/00

(52) U.S. Cl. CPC G02B 6/0035; G02B 30/52; G02B 6/0025; G02B 27/0172; G02B 27/0179; G02B 2027/0134; G02B 2027/014; G02B 2027/0178; G02B 2027/013; G02B 2027/0185; G09G 3/003

(57) ABSTRACT

A display system including an image source, an optical image deflector unit with an image entry surface, and a first optics arranged between the image entry surface and the image source. The image source generates image information for one or more focal distances which is directed towards the image entry surface by the first optics. The optical image deflector unit includes a first surface and a second surface. The first surface is arranged to reflect the directed image information towards a semi-reflective outcoupling surface, with an angle of incidence higher than a first angle. The semi-reflective outcoupling surface is arranged between the first and the second surface to reflect the reflected one or more image information towards the first surface, with an angle of incidence lower than the first angle. The image entry surface is arranged between the image source and a semi-reflective outcoupling surface.

### TECHNICAL FIELD

The present disclosure relates generally to near-eye display devices; and more specifically to a display system for generating a three-dimensional image. Further, the present disclosure relates to a method for generating the three-dimensional image. Furthermore, the present disclosure relates to a head mounted display system comprising the display system.

### BACKGROUND

Head mounted displays, also known as near-to-eye displays, are display devices worn on the head of a wearer. Such devices are widely used in aviation, engineering, gaming and medicine. The head-mounted displays having stereoscopic configuration conveys three-dimensional images in true sense. Herein, binocular disparities may be utilized that may be interpreted by the brain of the wearer as the three-dimensional (3D) image. However, in majority of cases, the image is output at a single focal plane, thus departing from natural way of how the human visual system operates. In other words, such head-mounted displays may suffer from vergence-accommodation mismatch or conflict. The vergence-accommodation mismatch may poorly reflect on the human experience when viewing the 3D images. Forceful decoupled mechanisms of eye accommodation and vergence may cause eyestrain which may ultimately lead to uncomfortable viewing experience; and if used for professional tasks, the vergence-accommodation mismatch may limit performance of the viewer.

In order to mitigate the vergence-accommodation conflict in stereoscopic near-to-eye displays several key architectures have been proposed. Conventionally, the stereoscopic near-to-eye displays may employ varifocal designs in order to diminish the vergence-accommodation conflict. Herein, the plane of accommodation is dynamically steered to match the actual vergence-distance. This may be achieved by utilizing a system for eye-tracking which registers a gaze direction for each eye and a focus-variable element. The focus-variable element may be, for example, a reciprocating screen with a fixed ocular, a varifocal lens such as a liquid electromechanical lens, a liquid crystal-based focus tuneable lens, an Alvarez lens and the likes. In practice, especially when see-through displays are considered which overlay digital content on top of a real-world view such designs are challenging as they make the device bulky and less robust. Moreover, the additional eye-tracking system may introduce a signal processing lag. Hence, when the varifocal designs are considered, the system might experience image delays that may possibly result in unpleasant viewing experience. Furthermore, varifocal designs may not provide realistic retinal defocus cues as the whole image plane is shifted towards the matching accommodative distance that may potentially interfere with the viewing experience and performance of the viewer. Moreover, a proposed computational blur has to be introduced to simulate realistic retinal blur, and that needs to be calculated which may require substantial computational resources.

Alternatively, a light-field near-to-eye display systems have been proposed which may be employed in order to provide consistent accommodation. Nevertheless, these systems are typically known to suffer from poor image quality in terms of resolution and brightness, image artefacts, limited eye box and complicated optical designs that may make the system bulky. Typically, the near-to-eye display systems attempting to achieve a thin footprint (glasses-like appearance) may utilize holographic or diffractive image waveguides. The main disadvantage of such displays is the lack of accommodation cues, which may still introduce vergence-accommodation mismatch thus making a display uncomfortable for near-content viewing.

Therefore, in light of the foregoing discussion, there exists a need to overcome various problems associated with conventional display system especially for near-work oriented generation of the 3D image, as in purely virtual reality environments and for augmented reality scenarios.

### SUMMARY

The present disclosure seeks to provide a display system and a method for generation of three-dimensional image (3D), and specifically addresses problems related to generally vergence-accommodation conflict and large footprint. Furthermore, the present seeks to provide a head mounted display system capable of conveying monocular focus cues and eye accommodation support, reducing a foot print in order to make the display device compact and substantially light. An aim of the present disclosure is to provide a solution that overcomes at least partially the problems encountered in prior art, and provides a display apparatus to provide a truthful generation of a three-dimensional image.

In one aspect, an embodiment of the present disclosure provides a display system comprising:

an image source to generate one or more image information for one or more focal distances, respectively;

a first optics arranged on the optical path between an image entry surface and the image source, wherein the first optics is arranged to direct one or more image information towards the image entry surface; and

an optical image deflector unit comprising:

a first surface and a second surface, wherein the second surface is opposite to the first surface,

the first surface arranged to reflect the directed one or more image information towards a semi-reflective outcoupling surface, wherein an angle of incidence between the directed one or more image information and the first surface is higher than a first angle,

the semi-reflective outcoupling surface arranged between the first and the second surface to deflect the reflected one or more image information towards the first surface, wherein the angle of incidence between the directed one or more image information and the first surface is lower than the first angle, and

the image entry surface arranged on an optical path between the image source and the semi-reflective outcoupling surface.

In another aspect, an embodiment of the present disclosure provides a head mounted display system comprising the display system as described above.

In yet another aspect, an embodiment of the present disclosure provides a method for generating 3D image, the method comprising:

generating one or more image information for a first focal distance with an image source;

directing the one or more image information towards an optical image deflector unit;

directing the one or more image information towards a first surface of the optical image deflector unit;

reflecting the one or more image information from the first surface towards a semi-reflective outcoupling surface of the optical image deflector unit; and

deflecting the one or more image information from the semi-reflective outcoupling surface towards the first surface of the optical image deflector unit.

Embodiments of the present disclosure substantially eliminate or at least partially address the aforementioned problems in the prior art, and enable truthful generation of the three-dimensional image. Further, the represented three-dimensional images cause substantially lower vergence-accommodation conflict, while the display device has a reduced footprint.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWING S

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a diagrammatic illustration of a head mounted display system for generating a three-dimensional image, in accordance with an embodiment of the present disclosure;

FIG. 2 is a diagrammatic illustration of the head mounted display system of FIG. 1 being worn by a viewer, in accordance with another embodiment of the present disclosure;

FIG. 3 is a schematic illustration of a display system implemented in the head mounted display system of FIG. 1 for generating the three-dimensional image to be viewed by the observer, in accordance with an embodiment of the present disclosure;

FIG. 4 is a simplified schematic illustration of the display system for generating the three-dimensional image, in accordance with an embodiment of the present disclosure;

FIG. 5 is a schematic illustration of the display system of FIG. 3 with an image source thereof having an image generator and a multi-layer optical chip, in accordance with one embodiment of the present disclosure;

FIG. 6 is a schematic illustration of the display system of FIG. 3 with an image source thereof comprising an orthogonal prism arrangement, in accordance with another embodiment of the present disclosure;

FIG. 7A is an exemplary diagrammatic top view illustration of the head mounted display system of FIG. 2, in accordance with an embodiment of the present disclosure;

FIG. 7B is an exemplary diagrammatic front view illustration of the head mounted display system of FIG. 2, in accordance with an embodiment of the present disclosure;

FIG. 7C is an exemplary diagrammatic side view illustration of the head mounted display system of FIG. 2, in accordance with an embodiment of the present disclosure;

FIG. 8A is a diagrammatic front view illustration of the head mounted display system depicting its various sections for manufacturability thereof, in accordance with an embodiment of the present disclosure;

FIG. 8B is a diagrammatic side view illustration of the head mounted display system depicting its various sections for manufacturability thereof, in accordance with an embodiment of the present disclosure; and

FIG. 9 is a flowchart listing steps of a method for generating the three-dimensional image, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a display system comprising:

an image source to generate one or more image information for one or more focal distances, respectively;

a first optics arranged on the optical path between an image entry surface and the image source, wherein the first optics is arranged to direct one or more image information towards the image entry surface; and

an optical image deflector nit comprising:

a first surface and a second surface, wherein the second surface is opposite to the first surface,

the first surface arranged to reflect the directed one or more image information towards a semi-reflective outcoupling surface, wherein an angle of incidence between the directed one or more image information and the first surface is higher than a first angle,

the semi-reflective outcoupling surface arranged between the first and the second surface to deflect the reflected one or more image information towards the first surface, wherein the angle of incidence between the directed one or more image information and the first surface is lower than the first angle, and

the image entry surface arranged on an optical path between the image source and the semi-reflective outcoupling surface.

In another aspect, an embodiment of the present disclosure provides a head mounted display system comprising the display system as described above.

In yet another aspect, an embodiment of the present disclosure provides a method for generating 3D image, the method comprising:

generating one or more image information for a first focal distance with an image source;

directing the one or more image information towards an optical image deflector unit;

directing the one or more image information towards a first surface of the optical image deflector unit;

reflecting the one or more image information from the first surface towards a semi-reflective outcoupling surface of the optical image deflector unit; and

deflecting the one or more image information from the semi-reflective outcoupling surface towards the first surface of the optical image deflector unit.

Throughout the present disclosure, the term “three-dimensional image” herein relates to an image that provides perception of depth to a viewer of the image. Herein afterwards, the terms “user”, “viewer” “observer” and “human” have been interchangeably used without any limitations. The three-dimensional image may be a volumetric image. Herein, the volumetric image may be an image having a height, a width, and a depth in the three-dimensional space. A given three-dimensional (3D) image could be a given volumetric image of at least one three-dimensional object (for example, such as a statue, a vehicle, a weapon, a musical instrument, an abstract design, and the like), a three-dimensional scene (for example, such as a beach scene, a mountainous environment, an indoor environment, and the like), and so forth. Moreover, the term “three-dimensional image” also encompasses three-dimensional computer-generated surfaces. Furthermore, the term “three-dimensional image” also encompasses a three-dimensional point cloud.

The term “display system” as used herein relates to a specialized equipment for presenting the three-dimensional (3D) image to a viewer in a manner that the three-dimensional image truthfully appears to have actual physical depth. In other words, the display system is operable to act as a device for visually presenting the three-dimensional image to be perceived in a three-dimensional space. Examples of such display system include televisions, computer monitors, portable device displays and so forth. Further, the display system includes display devices that may be positioned near eyes of a user thereof, such as, by allowing the user to wear (by mounting) the near-eye display apparatus on a head thereof. Examples of such near-eye display systems include, but are not limited to, head mounted displays (HMDs), head-up displays (HUDs), virtual-reality display systems, augmented-reality display system, and so forth.

The present display system may be employed in applications that require the viewer to perceive the depth of an object displayed within the image. Such a depth of the object may be an actual depth (or substantially close to the actual depth) of the object as opposed to a stereoscopic depth of the object that the viewer perceives during conventional stereoscopic reconstruction of object on a two-dimensional plane. For example, the display system may be employed by a product designer designing a product using computer-modelling software to perceive the product being designed from more than one direction at a time. In another example, the display system may be employed for medical application, such as, by a doctor to view a three-dimensional body-scan of a patient.

The image source generates one or more image information for one or more focal distances, respectively. As used herein, the term “image source” is intended to encompass all devices and displays, and the collective components thereof, that are capable of either producing image-bearing illumination or conveying image-bearing illumination from another source thereof. By the “image information” it is meant light emitted by the image source and the light is in the form of light rays. Therefore, by reflecting or deflecting one or more image information the light of an image is reflected or deflected.

Optionally, the image source is a multi-focal image source. In such multi-focal image source, the image content is represented at different focal distances with respect to the viewer, such as the viewer perceives a depth corresponding to the multiple depth planes of the image. Herein, the 3D image may be divided into two or more two-dimensional (2D) image slices that may be referred as the image information. That is, the image information corresponds to said image slices which in turn, corresponds to each of a planar portion of a 3D image. Such image slices of an object when put together enable the display of the 3D image, such that the viewer may perceive the depth of the object displayed within the 3D image. This way the multi-focal image source generates such 3D image by presenting the image information at different focal distances.

As discussed, the multi-focal image source may be configured to generate images with different focal distances, which are perceived by the observer as the magnified virtual image planes at different depths allowing the observer to freely accommodate onto any of them. That is, the multi-focal image source is configured to generate a real-time stream of 3D images comprising multiple image depth planes. The number of generated image depth planes comprising the whole view of a 3D image is any of 2, 3, 4, 5, 6, 7, 8, 9, 10, 12, 14, 15, 20. In other words the 3D scene may be approximated by 2, 3, 4, 5, 6, 7, 8, 9, 10, 12, 14, 15, 20 image depth planes.

In one of the embodiments, the multi-focal image source is configured to generate multiple focal planes substantially simultaneously. In this case, when multiple focal planes are generated substantially simultaneously, the possibility of depth-plane tear due to swift head or body movements of the viewer are virtually eliminated. In an embodiment, as discussed later in more detail, substantially simultaneous generation of focal planes is typically associated to multiple self-emissive micro displays which also virtually eliminates possibility of color breakup due to field-sequential color output as observed in binary spatial light modulators. Overall, this also simplifies motion prediction as no per-depth plane prediction is required, thus reducing motion-to-photon latency of the image processing-output pipeline. In another embodiment, as discussed later in more detail, the multi-focal image source is configured to generate multiple focal planes in a time-sequential manner. The time-sequential mode of operation typically may be associated with utilization of a binary field-sequential spatial light modulators and means such an array of electrically driven fast-switching optical diffusers for extracting depth information. The utilization of these components may have benefits from the perspective of perceived image quality such as, reduced perceived image flicker, substantially mitigated “screen-door” effect and the likes. Moreover, the rate at which the depth planes are output results in 3D image update rate of 60 Hz or more such as, 72 Hz, 80 Hz, 90 Hz, 120 Hz, 240 Hz, 360 Hz and the likes, thus allowing the viewer to perceive the time-sequential output stream of image depth planes as a continuous real-time 3D volume.

Optionally, the multi-focal image source comprises an orthogonal prism arrangement. Optionally, the orthogonal prism arrangement comprises a beam splitter, which is a device that splits a light beam. The orthogonal prism arrangement comprises of at least two micro-displays arranged on a common optical axis and is in the form of cube and has a first side, a second side, a third side and a fourth side. The second side is opposite to the first side and the fourth side is opposite to the third side, and the first side and the second side are orthogonal to the third side and fourth side. Furthermore, the orthogonal prism arrangement incorporates a first inner surface and a second inner surface. In one embodiment, the first inner surface and the second inner surface are orthogonal to each other and go through the cross sections of the surfaces first side with third side and third side with second side correspondingly. In another embodiment, the first inner surface and the second inner surface may be semi-reflective. Herein, the first inner surface and the second inner surface may partly reflect and transmit light. The term “semi-reflective” refers to a portion is partially reflective and partially transparent. The light rays passing through the semi-reflective first inner surface or the second inner surface may encounter a reflective section which may reflect the light rays and/or a transparent section which may allow the light rays to pass through. Moreover, a ratio of transmittance and reflection may be 1:1. That is, the first inner surface and the second inner surface may be 50% transparent or 50% reflective with absorbance as small as possible. It may be understood that, the image information may be carried over light rays. Moreover, the light incoming from the first side may be reflected towards the fourth side by the first inner surface, the light incoming from the second side may be reflected towards the fourth side by the second inner surface and the light incoming from the third side may pass through the first inner surface and the second inner surface reflective portion towards the fourth side.

Optionally, the multi-focal image source comprises at least two self-emissive micro displays. That is, the multi-focal image source comprising the orthogonal prism arrangement utilizing the self-emissive micro displays. Herein, two self-emissive micro display may be arranged around the either the first side and second side or the second side and the third side or the first side and the third side of the orthogonal prism arrangement. Optionally, the orthogonal prism arrangement comprises curved surfaces facing the micro displays. In the present implementations, the self-emissive micro displays may be employed in order to present the image information. Self-emissive micro displays may be, but not limited to, OLED or solid-state micro LED based displays which generate its own light type. Alternatively, similar effect can be achieved by utilizing LCD micro displays which are backlit by a bright source. As discussed, the image rendered by the display system is the 3D image. For this purpose, the 3D image may be divided into at least two-image information. Each of the two-image information may be displayed on one of the two self-emissive micro displays, and when they are viewed together the 3D image may be perceived by the viewer.

In an implementation, the multi-focal image source comprising the orthogonal prism arrangement may employ three self-emissive micro displays. Herein a first self-emissive micro displays may be arranged around the first side; a second self-emissive micro displays may be arranged around the second side and a third self-emissive micro displays may be arranged around the third side of the orthogonal prism arrangement. Furthermore, in order to generate virtual image planes with relevant distances from the viewer with large field of view, the self-emissive micro displays may be positioned as close as possible to the respective side of the orthogonal prism arrangement. The said distance may be in the order of hundred micrometers. Moreover, in order to obtain a separation in depth between the perceived virtual image depth planes, the self-emissive micro displays are positioned unequally from their respective side of the orthogonal prism arrangement. The differences between the distance at which the self-emissive micro displays may be positioned from the respective side of the orthogonal prism arrangement may be in in the range of 50-500 micrometers. For example, the first self-emissive micro displays may be positioned from the first side at a distance of 200 micrometers, the second self-emissive micro displays may be positioned from the second side at a distance of 270 micrometers and the third self-emissive micro displays may be positioned from the third side at a distance of 370 micrometers. The distance between the side and the respective self-emissive micro displays may be adjusted by utilization of high precision shims or realized by mechanically adjustable construction. It may be noted that when the multi-focal image source comprises at least two self-emissive micro displays the all of the image depth planes of the 3D image may be generated substantially simultaneously.

In an embodiment, the first inner surface and the second inner surface of the orthogonal prism arrangement may be polarization insensitive. The polarization insensitive nature of the first inner surface and the second inner surface may be beneficial, when combining the images from the first self-emissive micro display, the second self-emissive micro display and the third self-emissive micro display on a common optical axis, in case these image sources emit unpolarized light. In contrast, if the first micro display, the second self-emissive micro display and the third self-emissive micro display are configured to emit polarized light, the semi-reflective treatment of the first inner surface and the second inner surface may be polarization sensitive. That is, with high efficiency the first inner surface and the second inner surface may reflect or transmit the light of certain polarization. In this case, a more efficient utilization of the emitted light may be achieved when combining multiple images on a common optical axis.

Optionally, the multi-focal image source comprises an image generator comprising rear image projection unit and a multi-layer optical chip configured to define physical display planes, wherein the multi-layer optical chip comprises at least two display layers. The term “rear image projection unit” used herein relates to specialized equipment for projecting the plurality of image slices (portions) of the three-dimensional image. Herein, the image projection unit is arranged rear of the multi-layer optical chip and projects the plurality of image slices upon the multi-layer optical chip. The image projection unit may include a light source, a spatial light modulator, a processor and projection optics. The image projection unit relates to an arrangement of optical components (for example, such as lenses, mirrors, prisms, apertures, and the like) that are configured to direct a modulated light beam towards the multi-layer optical chip. Notably, the image projection unit allows for sharply focusing the plurality of image slices upon the multi-layer optical chip. The image projection unit provides a sufficient depth of field which encompasses a projection volume. As a result, sufficiently sharp images are displayed on the multi-layer optical chip. The image projection unit and the projection optics are configured to ensure a sufficient depth of field covering the majority of depth of the multi-layer optical chip. Therefore, no active measures of focusing are necessary. In such configuration, the focused image points are substantially equal on all physical display layers of the multi-layer optical chip. Therefore, the deviations are within +/−10%. Moreover, typically the projection unit and the projection optics are configured to ensure the sharpest image towards the centre of the multi-layer optical chip (mid focal planes). Optionally, when the apparatus is intended for near-work heavy tasks, then the sharpest focus may be diverted towards the furthest from the image projection unit depth planes, which when magnified are perceived as the closest virtual image planes to the viewer. Furthermore, the image projection unit may include an aperture to adjust at least a depth of field and a brightness of the plurality of image slices.

Optionally, the multi-layer optical chip is an array of electrically driven fast-switching optical diffusers having binary optical states: a first optical state comprising high light transmission and a second optical state comprising high haze values. Throughout the present disclosure, the term “optical diffuser” relates to an optical component that, in operation, displays a given virtual depth plane thereupon. Notably, the plurality of optical diffusers of a given multi-layer optical chip, in operation, receives a projection of a given virtual depth plane to display graphical information represented in the given image plane at the given display element. Therefore, the plurality of optical diffuser elements, in operation, receive projections of the plurality of virtual depth planes to display graphical information represented in the plurality of image planes.

Herein, the first optical state represents high light transmission and the respective optical diffuser is transparent. Thereby, the light passing through the optical diffuser may not interact with the medium of the optical diffuser and hence no image information may be presented on the optical diffuser in the first optical state. Further, the second optical state represents high haze values and the respective optical diffuser is opaque. Thereby, the optical diffuser interacts with the incident visible light by greatly scattering it and hence, the image information is presented on the optical diffuser in the second optical state. It will be appreciated that the optical diffuser acts as an electrically controllable screen, which passes light through itself whilst operating in the optically transparent state; and makes such light visible to the user whilst operating in the optically diffusing state. Therefore, in operation, each of the plurality of optical diffusers are rapidly and sequentially or non-sequentially switched between the at least two operational states, as required, to display the plurality of image planes. As a result, a visible effect of physical depth is produced within the three-dimensional image.

In one of the embodiments, the optically active medium of the optical diffusers within the multi-layer optical chip is a cholesteric liquid crystal free of any polymer stabilizing networks thus facilitating higher transparency values and faster switching between optical states. The utilization of liquid-crystal based optical diffusers as a means of generating image focal planes from the stream of projected 2D images has a number of benefits on the perceived image quality. Typically, when the self-emissive micro displays are highly magnified, pixel boundaries become visible resulting in a so-called “screen-door” effect. Utilization of optical diffusers even if the image source has the distinct boundary between pixels may have positive effect due to slight to moderate blending of the pixels without sacrificing the image resolution. The substantial masking of the sharp pixel boundaries may yield a perceptually more desirable image having a higher perceived image resolution.

Optionally, thickness of the at least two display layers is in the range of 4-15 micrometres for each display layer and wherein the distance between each display layer is in the range of 80-450 micrometres. In an embodiment, the thickness of the at least two display layers is 4, 5, 6, 7, 8, 9, 10, 11, 12, 13, 14 or 15 micrometres. Herein, each of the display layers may have same or different thickness without any limitations. Further, in an embodiment, the distance between each display layer is 80, 100, 150, 250, 300, 350, 400 or 450 micrometres. Again, herein, the distance between any two pair of adjacent display layers may be same or different without any limitations. In the present examples, the thickness and/or the distance are chosen so that the two display layers may be implemented in compact devices such as the head mounted display, while presenting the 3D image to the viewer in a manner that the three-dimensional image truthfully appears to have actual physical depth.

Optionally, the image source further comprises a driving and processing unit communicably coupled to the optical chip and the image generator, wherein the driving and processing unit is configured to: drive the display layers of the optical chip one by one in a sequential or non-sequential manner from the first optical state to the second optical state, to keep the selected display layer of the optical chip in the second optical state for a period of time equal to or larger than 500 microseconds, and to follow a switching from the second optical state to the first optical state. For purposes of the present disclosure, considering an example in which the optical chip comprises three display layers. Each of the display layers of the optical chip may be driven to change from the first optical state to the second optical state. Initially, the first display layer may be changed from the first optical state to the second optical state. At that instant, the second and the third display layer may remain in the first optical state. Hence, the image may be presented on the first display layer whereas, the second and the third display layers may be transparent. That is, the driving and processing unit substantially simultaneously within the period of time in which the selected layer of optical chip is in the second optical state, outputs the intended image information in the form of 2D image depth plane. Moreover, as the selected display layer of the optical chip transitions from the second optical state to the first optical state, the following display layer in the order of the optical chip may be activated to undergo the similar procedure. That is, the first display layer may be kept in the second optical state for 500 seconds. Next the second display layer may be changed from the first optical state to the second optical state and subsequently the first and the third display layers may be kept in first optical state. Furthermore, as the given display layer of optical chip undergoes a state change from the second optical state to the first optical state, the driving and processing unit may configure the image generator to switch off all the image sources until a following display layer of the optical chip has not completed the transition from the first optical state to the second optical state by at least of 90%.

As discussed, the optical image deflector comprises the first surface and the second surface, with the second surface being opposite to the first surface. In an embodiment, the first surface and the second surface are flat and substantially parallel. In alternative embodiment, the first surface and the second surface are curved. The optical image deflector unit further comprises the semi-reflective outcoupling surface. The semi-reflective outcoupling surface may be inclined and may connect the first surface and the second surface at some angle. Herein, the term “semi-reflective” represents that a part of the light intensity is transmitted and/or absorbed, while other part of the light intensity is reflected. Furthermore, the optical image deflector unit comprises the image entry surface that connect the first surface and the second surface such that, the image entry surface forms the cross section of the cylinder. In the disclosed configuration of the display system, the image entry surface faces the first optics. In one embodiment the semi-reflective outcoupling surface is embedded structure inside of the optical image deflector and it is not in contact with the first or the second surface. According to an embodiment the optical image deflector comprises a first part and a second part having connected with the semi-reflective outcoupling surface arranged between the first part and the second part. In one embodiment the first optics can be embedded as part of the optical image deflector unit. Indeed, for example the image entry surface can be considered to form the first optics.

As discussed, the image source presents the image information in the form of light comprising light rays. The light carrying image information from the image source may be directed towards the optical image deflector unit through at least one independent optical surface of the first optics. For the purpose of the present invention, the term “first optics” refers to a light transmittable optical element which may cause light to either converge (i.e., concentrate or focus) or to diverge (i.e., diffuse or scatter). In some implementations, the first optics may be one or a combination of lenses which may comprise different shapes, for example, may be biconvex (also called double convex, or just convex) if both surfaces are convex, may be biconcave (or just concave) if both surfaces are concave, may be plano-convex or plano-concave if one of the surfaces is flat or planar, may be convex-concave (or concave-convex) if one side is convex and one side is concave side, may be a meniscus lens (i.e., if the curvature of both sides is equal). The first optics may also comprise various light transmitting materials, such as glass, plastic, etc. Lenses may be formed by refractive or diffractive means (e.g., zone plates, diffractive optical elements (DOEs), etc.).

Optionally, the image source and the first optics are configured to generate images with multiple focal distances. That is, the image source and the first optics may work in conjunction to generate images with multiple focal distances, in order to present the 3D image to the viewer in a manner that the three-dimensional image truthfully appears to have actual physical depth. It may be understood that in case of the image source comprising the orthogonal prism arrangement, the fourth side of the orthogonal prism arrangement may incorporate the first optics. In an embodiment, the first optics may be an integral part of the orthogonal prism arrangement. Generally, it is curved and thus, may have an optical strength. In alternate embodiment, the orthogonal prism arrangement may be a separate part and the first optics is attributed to different optical element and may be coupled to the fourth side of the orthogonal prism arrangement via physical contact. For example, the first optics may be adhered by using an optical cement. The first optics may also be free with a gap between the first optics and the orthogonal prism arrangement.

Optionally, the first optics is a refractive or a reflective optical element. In an embodiment, the first optics is refractive. Herein, a simpler design may be achieved with smaller footprint. However, utilization of refractive first optics may introduce unwanted chromatic aberrations. Hence, if the first optics is refractive it may be configured to correct for chromatic aberrations by introducing other optical elements within the optical path. In an alternative embodiment, the first optics is reflective. Herein, the first optics may be employed for directing light and forming the 3D image without introduction of additional chromatic aberrations. Generally, the geometry of the first optics may be a freeform. In alternative embodiments, the geometry of the first optics may be one of aspherical, spherical, parabolic and bi-conic. In alternative embodiments, the first optics may be one of an optical meta surface, a holographic optical element and diffractive optical element that may allow additional more specific control of optical functions of the first optics while reducing its footprint. According to one embodiment the first optics have a first focal length and the image source is arranged to be closer to the first optics than the first focal length (i.e. between the first optics and the first focal length). Technical effect of this is to create virtual image. In alternative embodiment the image entry surface and the first optics form optically a second focal length. The image source is arranged to be closer to the combination of the first optics and the image entry surface than the second focal length. Technical effect of this is to create virtual image.

Optionally, at least one of the semi-reflective outcoupling surface, the image entry surface, the first surface, the second surface is bi-conic. In general, the semi-reflective outcoupling surface may have the freeform geometry. Alternatively, the semi-reflective outcoupling surface may have aspherical geometry, spherical geometry, parabolic geometry or bi-conic geometry. The preferred geometry of the semi-reflective outcoupling surface is bi-conic. The bi-conic geometry ensures simpler manufacturing the semi-reflective outcoupling surface while allowing anisotropic magnification of the image information which is required to overcome geometrical constraints introduced by a thin form-factor of the optical image deflector unit. The bi-conic geometry may help in an effective reflection of the image from the image source within the optical image deflector unit. Alternatively, the semi-reflective outcoupling surface may be configured as the freeform to be used within optical image deflector unit and may be configured to have optical strength. In this case the freeform geometry of the semi-reflective outcoupling surface may allow incorporating corrective functions also for the projected virtual 3D image which in turn facilitates a simpler design with lower count of optical surfaces.

In the present implementations, the image entry surface through which the light enters the optical image deflector unit is curved. Generally, the image entry surface is freeform. Alternatively, the geometry of the image entry surface is one of aspherical, spherical, parabolic or bi-conic. The preferred geometry for the image entry surface is also bi-conic, which helps in effective introduction of the image information from the image source into the optical image deflector unit.

The first surface is arranged to reflect the directed one or more image information towards the semi-reflective outcoupling surface, wherein an angle of incidence between the directed one or more image information and the first surface is higher than a first angle. The semi-reflective outcoupling surface is arranged between the first and the second surface in order to deflect the reflected one or more image information towards the first surface, wherein the angle of incidence between the directed one or more image information and the first surface is lower than the first angle. Also, there is no reflection of the one or more image information from the second surface before the one or more image information is deflected from the first surface. Furthermore, the image entry surface is arranged on an optical path between the image source and a semi-reflective outcoupling surface. As already mentioned before, by the image information it is meant light emitted from the image source in the form of light rays.

It may be understood that, the semi-reflective outcoupling surface is treated to be semi-reflective. In one of the embodiments, the semi-reflective treatment is polarization-independent. When used in conjunction with the image sources not having a natural polarization that are known as unpolarized light sources, the polarization independent treatment enables more effective utilization of the light ensuring improved overall brightness of the 3D image. In another embodiment, the semi-reflective nature is achieved by reflecting light with certain polarization while absorbing and transmitting the light with opposite polarization. This approach is preferred when using the image sources that have a natural polarization, or in some cases, the polarization is achieved by additional polarization filters. Herein, a more efficient reflection with considerably lower light intensity loses may be achieved by employing such semi-reflective outcoupling surface. In some examples, the semi-reflective outcoupling surface may be embedded within the bulk of the optical image deflector unit.

In one or more embodiments, at least a portion of the first side and the second side which corresponds to the projection of the semi-reflective outcoupling surface onto the respective sides is treated with anti-reflective coating. For example, a portion of the first side where the image information strikes the first side through the image entry surface may be reflective. This is necessary in order to reflect the image information from the first side towards the semi-reflective outcoupling surface. The rest of the portion of the first side may be treated with anti-reflective coating so that, when the image information strikes the first surface after reflection from the semi-reflective outcoupling surface, the image information is not reflected again. Rather, it is sent to the eyes of the viewer.

Optionally, the optical image deflector unit is a transparent optical image deflector unit, which is transparent to visible part of the electromagnetic spectrum. Herein, the reflective nature of the semi-reflective outcoupling surface with the transparent nature of the optical image deflector unit may allow the light from the ambient real-world to reach the observer. In this case, the semi-reflective treatment allows for 50%-90% of visible light spectrum intensity to reach the observer. This is particularly helpful when an augmented realty image needs to be generated where the virtual image needs to be presented in the real-world view.

Optionally, the optical image deflector unit has a geometry, which is configured to limit reflections of light from the first surface to one reflection before reflecting from the semi-reflective outcoupling surface. The optical image deflector unit is configured to reflect the incoming light rays from the first surface no more than one time prior to reaching the semi-reflective outcoupling surface while not reflecting off on the second surface. The optical arrangement of the optical image deflector unit is configured in a way that the light does not reflect from the second surface before it is deflected from the outcoupling surface. The light is in the form of light rays and is meant as image information generated by the image source. One technical effect of this limitation to only one reflection is that each reflection will result to loss of image information (generation of noise due to impurities, some light might not be fully reflected etc). Furthermore, a technical effect of the minimum count of reflections (one) within the optical image deflector unit such as from the first surface facilitates reduction of the overall optical path from the image source to the viewer thus enabling larger field of view, which is an important parameter while considering application in the head-worn display system. It may be understood that at each reflection some image information may be lost and hence, increase in the number of reflections may reduce the intensity of light available for eye of the user In some examples, though the optical image deflector unit may be designed to reflect light several times from the first and the second surfaces, it is quite important to reduce the count of reflections thus reducing the optical path in order to increase the field of view and intensity of light.

Optionally, the semi-reflective outcoupling surface, the image entry surface and at least part of the first surface is selected from an optical meta surface, a holographic optical element, a diffractive surface. In one embodiment, the semi-reflective outcoupling surface is the optical meta surface. In another embodiment, the semi-reflective outcoupling surface is implemented as the holographic optical element such as a thin layer of volume holographic grating. In yet another embodiment, the semi-reflective outcoupling surface is the diffractive surface having a thin layer adjacent to the semi-reflective outcoupling surface with a refractive index different from the refraction index of surrounding the semi-reflective outcoupling surface region of optical image deflector unit. The utilization of either the meta surface or the holographical optical element or the diffractive surface along with tailored and embedded optical functionality on the semi-reflective outcoupling surface may improve image metrics. Herein, the field of view may be increased, the colour and geometrical aberrations may be reduced and other optical functions beneficial for the viewing experience such as, inversing the optical functionalities according to the vision impairments of the viewer may be beneficially introduced. That is, the display system may be alleviated and the image deteriorations introduced by other optical surfaces within the optical path from the image source to the viewer may be mitigated by the use of either meta surface or the holographical optical element or the diffractive surface.

In an embodiment, at least a part of the first surface corresponding to the projection of the semi-reflective outcoupling surface is treated with one of the meta surface, the holographic optical element and the diffractive surface. With this additional optical functionality may be introduced within the optical path from the image source to the viewer without unnecessary bulkiness or without increase in the footprint of the display system in comparison to the case without mentioned treatment of the first surface. One of such functionalities that may be improved is further increase of the field of view for the projected virtual 3D image. Moreover, the said treatment may add optical strength to the said region of the first surface for the image information of defined wavelengths. That is, the rest of the wide-spectrum of light passing through the surface from the ambient real-world would not be affected. Similarly, the image entry surface may also be selected from one of the meta surface, the holographic optical element and the diffractive surface. The benefits would be similar to the ones as discussed above.

Optionally, the first surface and the second surface have equal curvatures. As discussed, in an embodiment, the first surface and the second surface are parallel to each other forming uniform thickness of the optical image deflector unit. Herein, the curvatures of both the first surface and the second surface are substantially similar in order to ensure an optically neutral medium for image information passing through the optical image deflector unit from the ambient real world towards the eyes of observer. The flatness or curvature of the first surface and the second surface in the case of optically neutral configuration may be associated to aesthetic properties of the display system and how it is socially received in familiar way. Nevertheless, in alternative embodiments, the first surface and the second surface may have curvature of dissimilar characteristics ensuring the optical image deflector unit has the optical power. In this case the optical image deflector unit acts as regular corrective optical element and is used for vision correction purposes. For example, the first surface may be flat and the second surface may be curved. The second surface may thus provide power according to the visual impairments of the viewer.

Optionally, the optical image deflector unit has an index of refraction higher than 1.45. It must be noted that generally the optical image deflector unit is comprised of optically transparent material with index of refraction preferably higher than 1.45 in order to ensure as short as possible optical path from the image source towards the viewer. In this respect, the refraction index of the first optics may be chosen to be substantially different from the refraction index of the surrounding optical image deflector unit. In an embodiment, the first optics may be implemented as a void with air inside, thus having an index of refraction lower than that of optical image deflector unit, that is generally being close to 1. In alternative embodiment, the first optics may be implemented by encapsulation of material with an index of refraction that is higher than that of optical image deflector unit without any limitations.

Optionally, the first angle is a critical angle. As may be understood, the “critical angle” is the angle of incidence where a total reflection takes place for a ray of light. The critical angle can be calculated for any interface of two material using Snell's law. Indeed, the critical angle is A=arcsin(n₂/n₁), wherein n₁ is index of refraction for the optically transparent material of the optical image deflector unit. As an example if the transparent material is polycarbonate with n₁=1.60 then critical angle is arcsin(1/1.60)=38.68 degrees (since index of refraction of air is 1). For material such as PMMA (polymethacrylate) n₁=1.48 leading to critical angle of arcsin(1/1.48)=42.5 degrees. According to alternative embodiment the optical image deflector unit might be embedded inside of another material than the optical image deflector unit or the first surface of the optical image deflector unit can be coated with another material than the optical image deflector unit. In such a case the critical angle can be further controlled. For example if the transparent material is polycarbonate with n₁=1.60 and the first surface is coated with PMMA (n₂=1.48) then the critical angle would be arcsin(1.48/1.60)=67.7 degrees. By angle of incidence we refer to angle between a ray of light and to a normal surface i.e. if angle of incidence is 0 then the ray of light will go directly towards the surface and if the angle of incidence is 90 degrees than the light will be parallel to the surface.

When the angle of incidence, is greater (higher) than the critical angle, whole of the light is reflected. In such cases, the intensity of reflected light is similar to the incident light and minimal losses occur. In order to reflect all of the image information towards the semi-reflective outcoupling surface, the angle of incidence between the directed light and the first surface must be higher than the critical angle (i.e. the first angle). It may be appreciated that if the angle of incidence between the directed light and the first surface is lower than the critical angle some of the light may be refracted into air surrounding the optical image deflector; and hence the intensity of the light reflected towards the semi-reflective outcoupling surface may decrease.

Optionally, the angle of incidence which is higher than the first angle is between 45 and 85 degrees. That is, the angle of incidence between the directed one or more image information and the first surface is between 45 and 85 degrees. In an embodiment, the angle of incidence which is higher than the first angle is 45, 50, 55, 60, 65, 70, 75, 80 or 85 degrees. Such angle of incidence which is higher than the first angle is so chosen so to limit the number of reflections and hence, reduce the optical path length.

Optionally, the angle of incidence which is lower than the first angle is between 0 and 45 degrees. That is, the angle of incidence between the deflected one or more image information and the first surface is between 0 and 45 degrees. In an embodiment, the angle of incidence which is lower than the first angle is 5, 10, 15, 20, 25, 30, 35, 40 or 45 degrees. The angle of incidence which is lower than the first angle is chosen so that the light rays are transmitted to the eyes of the viewer thru the first surface; otherwise, the light rays may get reflected from the first surface and not reach the eyes of the viewer.

As the light travels through the optical image deflector unit, the configuration is set to reflect the light due to total internal reflection one time off of the first surface of the optical image deflector unit prior it hits the semi-reflective outcoupling surface, while not reflecting off from the second surface of the optical image deflector unit. Herein, the semi-reflective outcoupling surface is configured to be semi-reflective, for example with 30% reflectivity, facilitating bright view of the surrounding real-world environment. The semi-reflective surface is also configured to have an optical strength which also anisotropically magnifies the incident image. Furthermore, the semi-reflective surface is configured to compensate the first anisotropic magnification introduced by any optical element in between, thus presenting the viewer with perceptually correct aspect ratio of the image.

As per embodiments of the present disclosure, the “head mounted display system” is a display device which may be worn by the user, e.g., a part of a helmet to be worn on a head of the wearer. The head mounted display system includes the display system in front of one or each eye and may provide a 3D view in the virtual-reality environment and the augmented-reality environment. The head mounted display system may be used in applications such as, but not limited to, military, aviation, gaming, virtual cinema and medicine. The head mounted display system comprises a computational and image rendering unit, which is communicably coupled to the head mounted display system via bidirectional communications link. In an embodiment, the head mounted display system comprises the driving and processing unit which is communicably coupled to the computational and image rendering unit. In another embodiment, the computational and image rendering unit is integrated within the head mounted display system. In an embodiment, the communication link between the head mounted display system and the computational and image rendering unit is wired such as, but not limited to, a USB cable ensuring USB-C or similar standard connectivity such as, DisplayPort, Thunderbolt, HDMI and the likes. In another embodiment, in order to ensure increased data throughput, the computational and image rendering unit may be communicably coupled to the head mounted display system via more than one physical wired connections such as, two USB-C type cables, two HDMI cables, two thunderbolt cables, two DisplayPort cables etc. In yet another embodiment, the data communications link between the head mounted display system and the computational and image rendering unit is wireless such as, a high data throughput wireless connection such as extremely high frequency (EHF) Wi-Fi, for example 60 GHz Wi-Fi, and the likes. In case the whole computational and image rendering unit or at least part of its functionality is integrated within the head mounted display system, the data communications link to the driving and processing unit may be either wired or wireless. Optionally, in some cases both communications links (wired and wireless) may be established simultaneously between the head mounted display system and/or the computational and image rendering unit and the driving and processing unit. This is of practical use when different types of data have to be transmitted between the head mounted display system and the master software such as, programs typically running on the driving and processing unit. For example, a wired connection may be used for graphical data transfer utilizing high bandwidth while sensor feedback data may be transmitted through wireless communications link. It may be noted that different configurations for utilization of data channels are possible.

The important attributes of the head mounted display system may be transparent optical image deflector units. In an embodiment, two optical image deflector units may be placed corresponding to each eye of the viewer. The optical image deflector units may participate in the magnification and deflection of the image from the multi-focal image source. Protective light-transparent elements may be positioned in front of each of the optical image deflector units. In an embodiment, the protective elements may have optical strengths in case the observer requires vision correction. In such case, the 3D image may be compensated to match the vision of the observer through separate optical elements or several elements positioned on the optical path from the image source and the optical image deflector units. Alternatively, functionality of the protection may be merged with the functionality of image formation and deflection. In such case, the functionality of vision correction is directly attributed to the modified optical image deflector units. Optionally, the head mounted display system may be equipped with environmental sensory apparatuses. These sensory apparatuses may be any one of: a camera capturing visible spectrum, a camera capturing infrared spectrum, a depth sensing camera, and a time-of-flight camera. Moreover, the head mounted display system may be equipped with sensors in any arbitrary combination of the previously mentioned options. In an embodiment, the cameras capturing the visible spectrum may be in pairs in order to form a stereoscopic way of capturing surroundings. In alternative embodiment, the head mounted display system may be equipped with more than two environmental sensory apparatuses of similar kind such as, three visible-light cameras, four visible-light cameras, five visible-light cameras and the likes. The data from the environmental sensory apparatuses may be transmitted via wired bidirectional communications link to the computational and image rendering unit.

In an embodiment, the environmental sensory apparatuses and the computational and image rendering unit may be configured to perform simultaneous location and mapping of the real-world surroundings. In another embodiment, the environmental sensing apparatuses and the computational and image rendering unit may also be configured to capture the hand position of the observer thus enabling sensory input for the control and interactivity between the observer and the master software.

Moreover, the present description also relates to the method for generating three-dimensional image as described above. The various embodiments and variants disclosed above apply mutatis mutandis to the method for generating the three-dimensional image.

Optionally, the first image information of the method for generating 3D image is reflected from the first surface not more than one time before reaching the semi-reflective outcoupling surface.

The present disclosure further provides a method for manufacturing the optical image deflector unit, along with or without the first optics. The preferred method for manufacturing is injection moulding, injection-compression moulding or any other similar method that may yield a form with high precision. The said method may consist of manufacturing the optical image deflector unit as at least three separate components namely, a first component, a second component and a third component. In one of the embodiments, each of the first component, the second component and the third component may be moulded separately after which post-moulding treatments may be followed. For example, the first component may be treated to obtain the highly reflective first and second surfaces of the optical image deflector unit, which can be, for example, a vacuum thin film deposition method with application of masking for surfaces not requiring treatment. Similarly, the semi-reflective outcoupling surface of the second component may be treated with semi-reflective coating using the vacuum-deposition method for better precision. A preferred method for obtaining semi-reflective properties may be application of multi-layer dielectric coatings, which utilizes light interference phenomenon and in contrast to thin metallic films have very low light absorption. Afterwards all the said components may be coupled via optical cement. The optical image deflector unit and the first optics may be manufactured separately and introduced in the corresponding voids in the process of coupling all the comprising components together. Moreover, the first optics may be simply a void in the optical image deflector unit thus only requiring an optional treatment of corresponding surfaces on the first component and the second component with antireflective coating.

In an alternative method, the first component and the second component may be moulded and treated with corresponding coatings which may then be joined by optical cement or similar highly transparent optical adhesive, while the third component may be injected or poured in a liquid form directly in contact with the joined first and second component. In this method, an optical polymer with index of refraction substantially similar to that of the second component may be injected or poured within the mould which hold the first and second components and has a space with the specific geometry for the pouring of the third component. The pouring step may be followed by curing step which may be, for example, an ultra-violet photon induced polymerization, evaporation of solvents or thermally induced polymerization.

For the convenience of assembly of the head mounted display system and to alleviate assembly of the multi-focal imaging engine for the view of virtual content in the light of real-world surroundings in practise, it is desirable to derive a highly integrated solution. In this case, all of the optical surfaces may be integrated within the optical image deflector unit, with the image source mounted on top of the optical image deflector unit. In the case of the image source comprising the orthogonal prism arrangement, as the current micro displays, for example micro LED micro displays can achieve respectable image resolution (for example a Full-HD resolution) within small footprint, for example having a micro display with 0.2 inches, or even 0.13 inches diagonal or smaller, it becomes feasible to perform direct coupling of these image sources to the optical image deflector unit simultaneously keeping the footprint of the assembled head mounted display system compact. The particular benefit enable by small diagonal micro displays are thin, and glass like dimensions of the optical image deflector unit, for example a thickness of 6 mm, 5 mm, 4 mm or even 3.5 mm, can be feasible resulting in a compact multi-focal near-to-eye translucent digital 3D display. Here the optical image deflector unit incorporates two embedded curved surfaces which are attributed to the image sources (i.e. micro displays) respectively. The said surfaces are treated with a highly reflective coating facilitating efficient reflection of light emitted from the image sources towards the optical image deflector unit. In some examples, the light from the image source is directed within the optical image deflector unit directly without any intermediate optical surfaces having an optical strength. In this respect, the distance between the image sources from the corresponding surfaces of optical image deflector unit may vary. Nevertheless, to ensure rational placement of perceived virtual image depth planes from the viewer, the distances of image sources from the respective surfaces of the optical image deflector unit have to be substantially similar, as referred previously the differences should be within 50-500 micrometre range. In this case, the role of curved surfaces is to pre-magnify the respective image sources to compensate the optical path differences introduced by linear placement of image sources, or otherwise optically bring the image sources closer to the respective surfaces of the optical image deflector unit.

With the embodiments of the present disclosure, the present head mounted display system may be manufactured in the form of thin Augmented Reality (AR) glasses or the like. The present head mounted display system can be used as a stereoscopic system for professional use cases in enterprises, in medicine, etc. because of its ability to present the 3D image to the viewer in a manner that the image truthfully appears to have actual physical depth. In one or more examples, the present head mounted display system may be used in consumer markets, such as for more or less discrete personal assistance device providing supplemental information, helping to navigate, providing relevant information which can save time for a user, improve safety etc. In some instances, the present head mounted display system can be monocular, for example for some special cases which may be relevant for military applications or may be for some first-responders like firefighters.

### DETAILED DESCRIPTION OF THE DRAWINGS

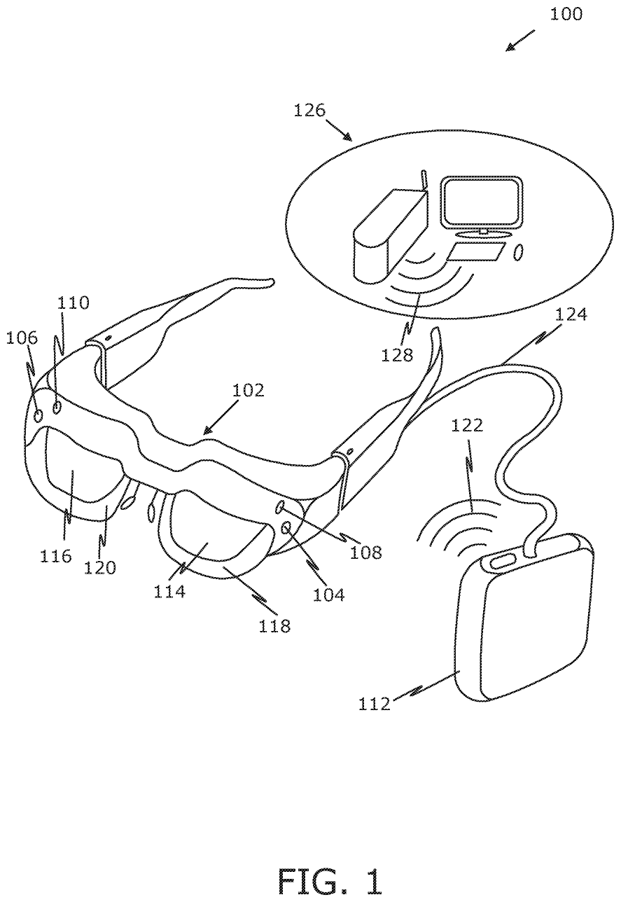

Referring to FIG. 1, there is shown a schematic illustration of a head mounted display system 100 for generating a three-dimensional image, in accordance with an embodiment of the present disclosure. The head mounted display system 100 comprises of a display system 102, a computational and image rendering unit 112 and a driving and processing unit 126. Herein, the display system 102 comprises a first optical image deflector unit 114, a second optical image deflector unit 116, a first protective light-transparent element 118, a second protective light-transparent element 120, a first environmental sensory apparatus 104, a second environmental sensory apparatus 106, a third environmental sensory apparatus 108 and a fourth environmental sensory apparatus 110.

The first protective light-transparent element 118 and the second protective light-transparent element 120 are positioned in front of the first optical image deflector unit 114 and the second optical image deflector unit 116. Optionally, the protective elements 118 and 120 may have optical strengths. The first environmental sensory apparatus 104 is a camera capturing visible spectrum. The second environmental sensory apparatus 106 is a camera capturing infrared spectrum. The third environmental sensory apparatus 108 is a depth sensing camera. The fourth environmental sensory apparatus 110 is a time-of-flight camera. The data from the environmental sensory apparatuses 104, 106, 108 and 110 is transmitted via a wired bidirectional communication link 124 to the computational and image rendering unit 112. Herein, the computational and image rendering unit 112 is communicably coupled to the head mounted display system 102 via the bidirectional communications link 124, and to the driving and processing unit 126 via a wireless communication link 122, 128.

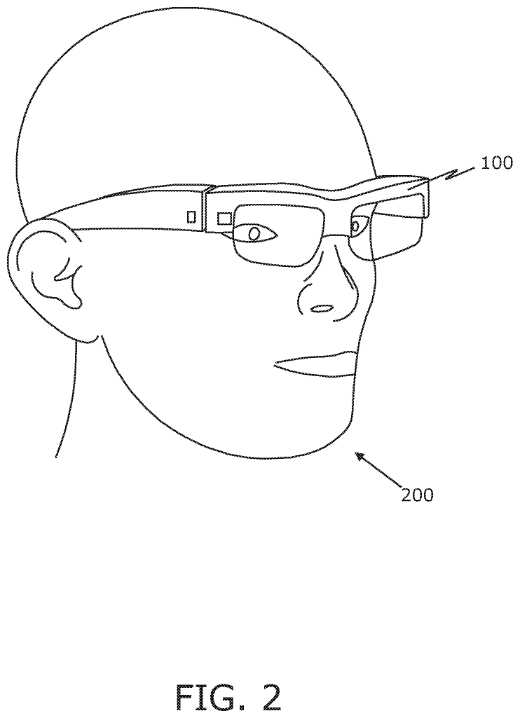

Referring to FIG. 2, there is shown a diagrammatic illustration of the head mounted display system 100 of FIG. 1 being worn by an observer 200, in accordance with another embodiment of the present disclosure. It will be appreciated that the head mounted display system 102 is in the form of glasses worn in front of the eyes of the observer 200.

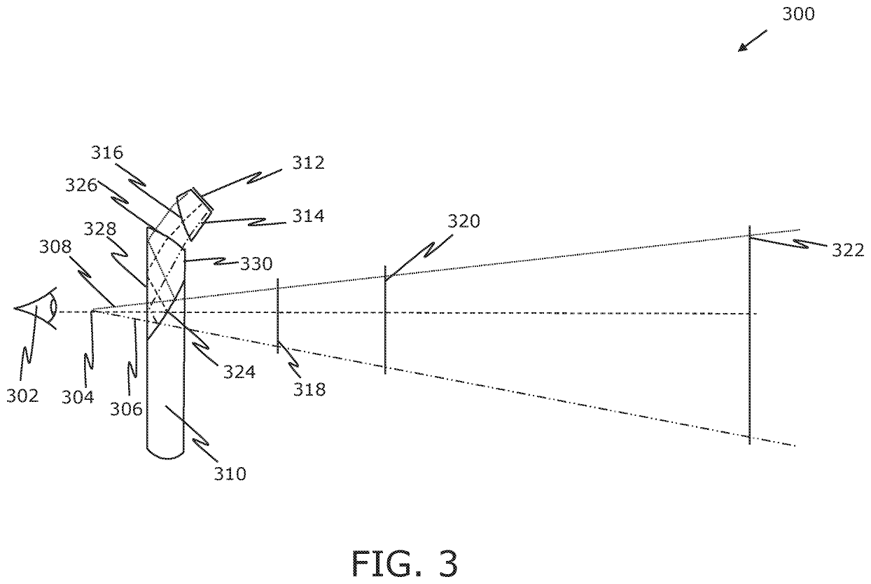

Referring to FIG. 3, there is shown a schematic illustration of a display system 300 implemented in the head mounted display system 100 of FIG. 1 for generating the three-dimensional image to be viewed by a viewer 302, in accordance with an embodiment of the present disclosure. The display system 300 comprises an image source 312, a first optics 314 and an optical image deflector unit 310. The display system 300 generates images at a first focal distance 318, a second focal distance 320 and a third focal distance 322. The image source 312 provides image information which is carried as light rays 304, 306 and 308. The first optics 314 is arranged on the optical path between an image entry surface 326 and the image source 312. Herein, the first optics 314 is arranged to direct the light from the image source 312 towards the image entry surface 326. A surface 316 of the first optics 314 is curved in order to facilitate in directing the light towards the image entry surface 326. The optical image deflector unit 310 comprises a first surface 328 and a second surface 330. The second surface 330 is opposite to the first surface 328. The first surface 328 is arranged to reflect the light towards a semi-reflective outcoupling surface 324. The semi-reflective outcoupling surface 324 is arranged between the first surface 328 and the second surface 330 to reflect the reflected one or more image information towards the first surface 328. The image entry surface 326 is arranged on the optical path between the image source 312 and the semi-reflective outcoupling surface 324.

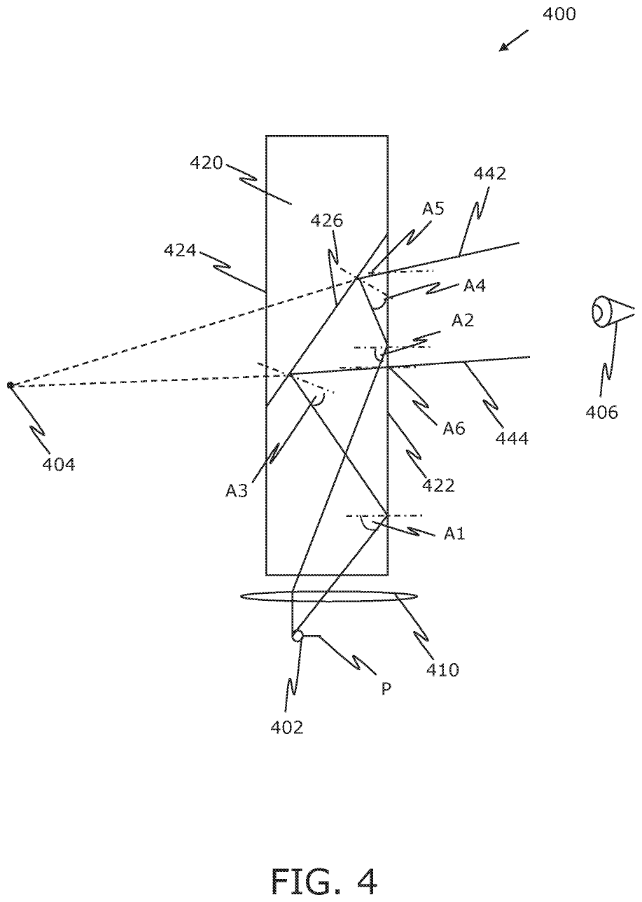

Referring to FIG. 4, there is shown a simplified schematic illustration of a display system 400 for generating a three-dimensional image, in accordance with an embodiment of the present disclosure. The display system 400 comprises an image source 402, a first optics 410 and an optical image deflector unit 420 with a first surface 422, a second surface 424 and a semi-reflective outcoupling surface 426. The image source 402 is positioned at a point P in front of the first optics 410. The point P is closer to the first optics 410 than a focal length f of the first optics 410. A first ray of light 442 from the image source 402 strikes the first surface 422 of the optical image deflector unit 420 at an angle of incidence A2. A second ray of light 444 strikes the first surface 422 of the optical image deflector unit 420 at an angle of incidence A1. The angle of incidences A1 and A2 are higher than a first angle which is a critical angle. The first ray of light 442 reflects from the first surface 422 and strikes the semi-reflective outcoupling surface 426 at an angle of incidence A4. Similarly, the second ray of light 444 reflects from the first surface 422 and strikes the semi-reflective outcoupling surface 426 at an angle of incidence A3. The first and the second rays of light deflect from the semi-reflective outcoupling surface 426 towards the first surface 422. The first deflected ray of light 442 strikes the first surface 422 at an angle of incidence A5. The second deflected ray of light 444 strikes the first surface 422 at an angle of incidence A6. The angle of incidence A5 and A6 are lower (smaller) than the first angle. Hence, only one reflection occurs at the first surface 422. Herein, the first ray of light 442 and the second ray of light 444 forms the image 404 at an eye of the viewer 406. Image is virtual image since the point P is closer to the first optics than focal length of the first optics.

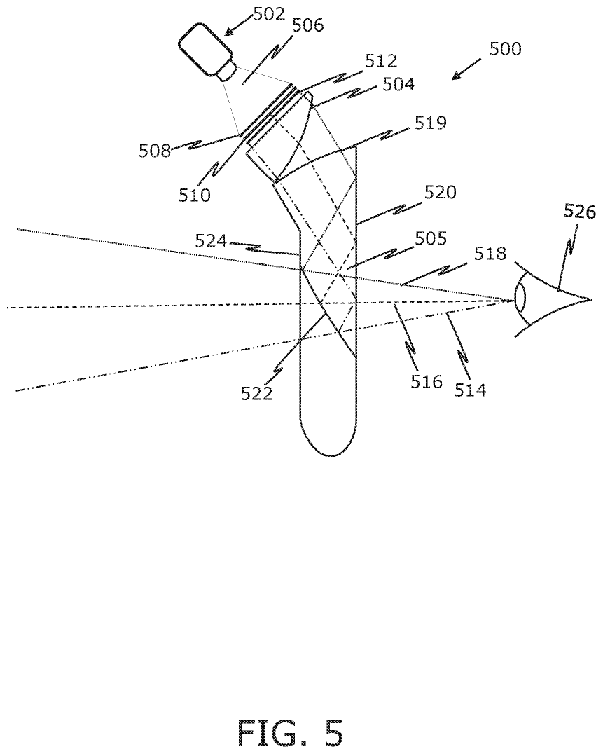

Referring to FIG. 5, there is shown a schematic illustration of a display system 500 for generating a three-dimensional image, in accordance with another embodiment of the present disclosure. The display system 500 comprises an image generator 502, a first optics 504 and an optical image deflector unit 505. The image generator 502 comprises a rear image projection unit 506 and a multi-layer optical chip defining physical display planes such as, a first display plane 508, a second display plane 510 and a third display plane 512. The multi-layer optical chip is implemented as an array of electrically driven fast-switching optical diffusers 508, 510 and 512 with binary optical states: a first optical state comprising high light transmission and a second optical state comprising high haze values.

Light rays 514, 516 and 518 are directed into the optical image deflector unit 505 by the first optics 504 via an image entry surface 519 in order to reflect from a first surface 520 followed by deflection from a semi-reflective outcoupling surface 522, extending between the first surface 520 and a second surface 524, and finally reach the eye 526.

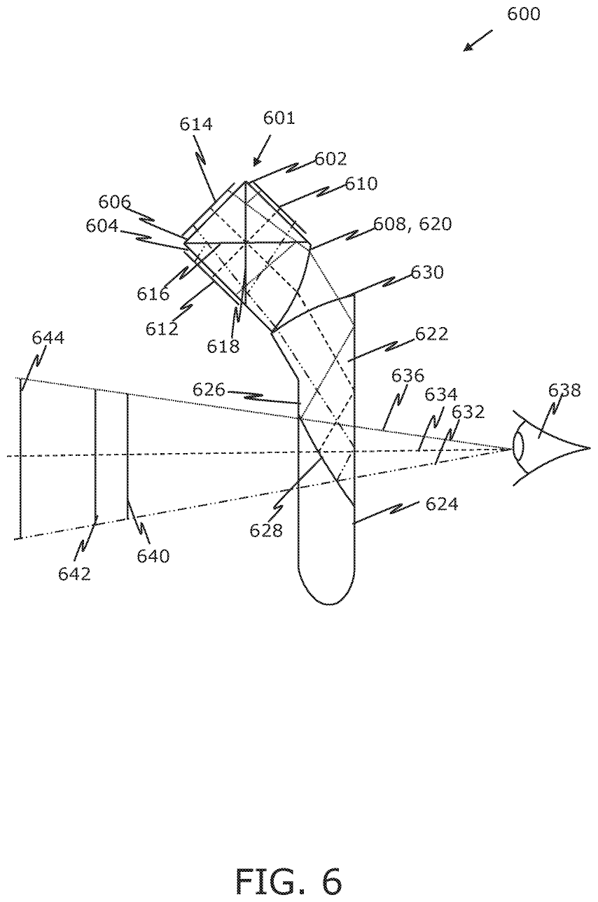

Referring to FIG. 6, there is shown a schematic illustration of a display system 600 for generating a three-dimensional image, in accordance with an embodiment of the present disclosure. The display system 600 includes a orthogonal prism arrangement 601. The orthogonal prism arrangement has a first side 602, a second side 604, a third side 606 and a fourth side 608. The second side 604 is opposite to the first side 602, and the fourth side 608 is opposite to the third side 606. The first side 602 and the second side 604 are orthogonal to the third side 606 and the fourth side 608. Further, a first self-emissive micro display 610 is arranged around the first side 602, a second self-emissive micro display 612 is arranged around the second side 604 and a third self-emissive micro display 614 is arranged around the third side 606 of the orthogonal prism arrangement 601. The self-emissive micro displays 610, 612 and 614 are positioned as close as possible to the respective side of the orthogonal prism arrangement 601. Furthermore, the orthogonal prism arrangement 601 includes a first inner surface 616 and a second inner surface 618. The first inner surface 616 and the second inner surface 618 are orthogonal to each other. Furthermore, the first inner surface 616 and the second inner surface 618 are semi-reflective. Herein, the fourth side of the 608 of the orthogonal prism arrangement 601 being curved also works as the first optics 620. The display system 600 further includes an optical image deflector unit 622 with a first surface 624, a second surface 626, a semi-reflective outcoupling surface 628 and an image entry surface 630.

Light rays 632, 634 and 636 emitted from the self-emissive micro displays 610, 612 and 614, respectively, are directed into the optical image deflector unit 622 by the first optics 620 via the image entry surface 630. The light ray 632 from the first self-emissive micro display 610, the light ray 634 from the second self-emissive micro display 612 and the light ray 636 from the third self-emissive micro display 614 bend while passing through the first optics 620 which is integrated with the fourth side 608. The light rays 632, 634 and 636 reflects from the first surface 624 only once and strikes the semi-reflective outcoupling surface 628 following which the light rays 632, 634 and 636 enter the eye 638 in order to create a 3D image with virtual image depth planes 640, 642 and 644. Herein, in order to obtain a separation in depth between perceived virtual image depth planes 640, 642 and 644, the self-emissive micro displays 610, 612 and 614 are positioned unequally from their respective side 602, 604 and 606 of the orthogonal prism arrangement 601.

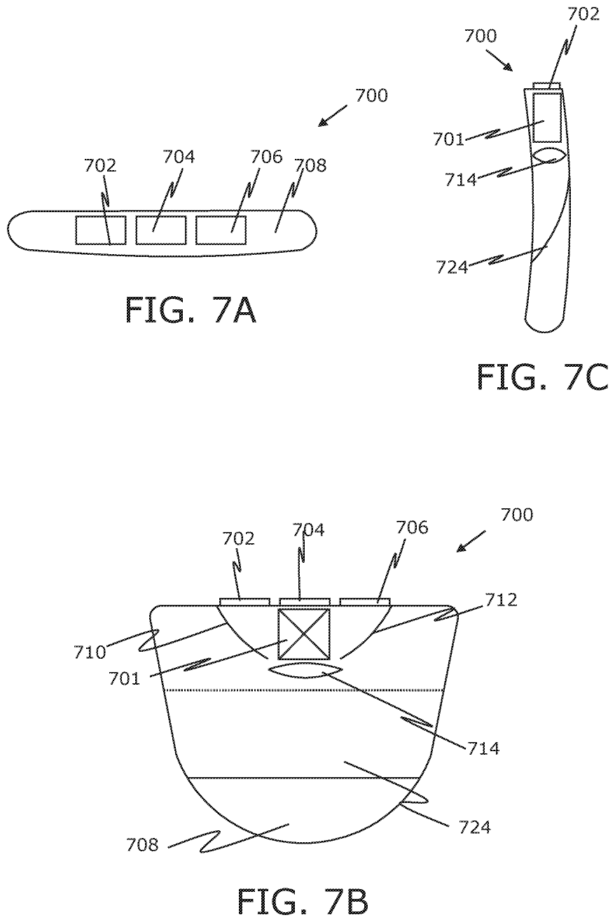

Referring to FIG. 7A, there is shown a schematic illustration of a top view of a head mounted display system 700 (similar to the head mounted display system 100 of FIG. 1) for generating the three-dimensional image, in accordance with an embodiment of the present disclosure. Referring to FIG. 7B, there is shown a schematic illustration of a front view of the head mounted display system 700 for generating the three-dimensional image, in accordance with an embodiment of the present disclosure. Referring to FIG. 7C, there is shown a schematic illustration of a side view of the head mounted display system 700 for generating the three-dimensional image, in accordance with an embodiment of the present disclosure.

Referring to FIGS. 7A, 7B and 7C in combination, the head mounted display system 700 comprises an orthogonal prism arrangement 701 with micro displays 702, 704 and 706 that are mounted on top of an optical image deflector unit 708 therein. The micro displays 702, 704 and 706 are self-emissive micro displays that are micro LEDs to achieve respectable image resolution with small footprint. Herein, a first surface 710 and a second surface 712 of the optical image deflector unit 708 are integrated therewith, whereas the micro displays 702, 704 and 706 are mounted on top of the optical image deflector unit 708. The optical image deflector unit 708 includes curved surfaces 710 and 712 that are attributed to the micro displays 702 and 706 respectively. The surfaces 710 and 712 are treated with a highly reflective coating facilitating efficient reflection of light emitted from the micro displays 702 and 706 towards the orthogonal prism arrangement 701. In contrast the light from the micro display 704 is directed within the optical image deflector unit 708 directly. In this respect the distance between the micro displays 702, 704 and 706 from the corresponding surfaces of optical image deflector unit 708 are substantially different. Nevertheless, to ensure rational placement of perceived virtual image depth planes from the viewer, the distances of micro displays 702, 704 and 706 from the respective surfaces of the optical image deflector unit 708 are substantially similar. In this case the role of curved surfaces 710 and 712 are to pre-magnify the respective micro displays 702 and 706 to compensate the optical path differences introduced by linear placement of micro displays 702, 704 and 706. In this way the micro displays 702, 704 and 706 are brought optically closer to the respective surfaces of the optical image deflector unit 708. When the light from the respective micro displays 702, 704 and 706 is combined on a common optical axis at the output surface of the orthogonal prism arrangement 701, it exits the orthogonal prism arrangement 701 to enter a first optics 714. The geometry of first optics 714 is configured to facilitate anisotropic magnification (expansion) of the incident image. The higher magnification is achieved in the direction perpendicular to the thickness of the optical image deflector unit 708.

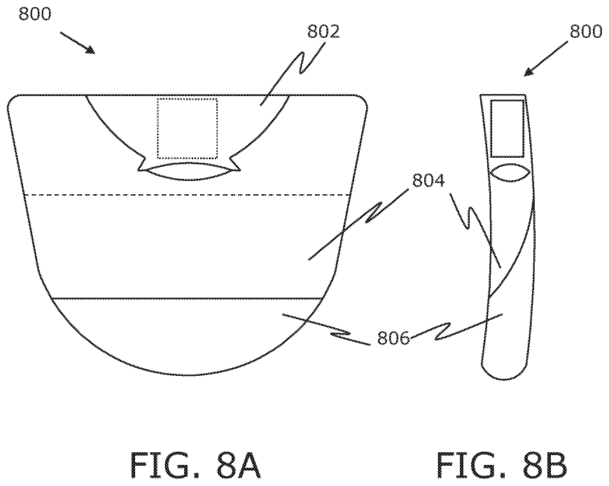

Referring to FIG. 8A, there is shown a schematic illustration of manufacturing the front view of the head mounted display system 800 for generating the three-dimensional image, in accordance with an embodiment of the present disclosure. Referring to FIG. 8B, there is shown a schematic illustration for manufacturing of the side view of the head mounted display system 800 for generating the three-dimensional image, in accordance with an embodiment of the present disclosure.

Referring to FIGS. 8A, 8B and 8C in combination, a head mounted display system 800 is illustrated which is divided into three components: a first component 802, a second component 804 and a third component 806. The first component 806, the second component 804 and the third component 802 are moulded separately after which post-moulding treatments are followed. The second component 804 is treated to obtain a highly reflective first and second surfaces of an optical image deflector unit (not shown) by a vacuum thin film deposition method with application of masking for surfaces not requiring treatment. A semi-reflective outcoupling surface 810 of the second component is treated with semi-reflective coating using the vacuum-deposition method for better precision. Afterwards all the said components are coupled via optical cement. The third component 802 which include first optics (not shown) are manufactured separately and introduced in the corresponding voids in the process of coupling the components 802, 804 and 806 together. Indeed, by combining the first component 804 and the second component 806 together the semi-reflective outcoupling surface 810 is arranged between the components and between the first and the second surface of the optical image deflector unit.

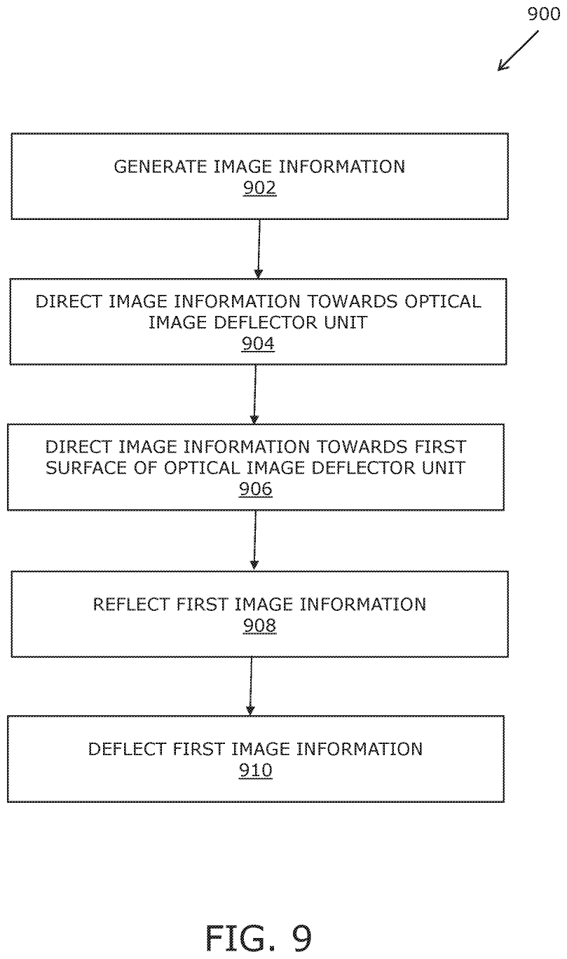

FIG. 9 is a flowchart 900 listing steps of a method for generating a three-dimensional image, in accordance with another embodiment of the present disclosure. The method includes, at a step 902, generating one or more for a first focal distance with an image source. The method includes, at a step 904, directing the one or more image information towards an optical image deflector unit. The method includes, at a step 906, directing the one or more image information towards a first surface of the optical image deflector unit. The method includes, at a step 908, reflecting the one or more image information from the first surface towards a semi-reflective outcoupling surface of the optical image deflector unit. The method includes, at a step 910, deflecting the one or more image information from the semi-reflective outcoupling surface towards the first surface of the optical image deflector unit.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display system comprising:
an image source to generate one or more image information for one or more focal distances, respectively;
a first optics arranged on the optical path between an image entry surface and the image source, wherein the first optics is arranged to direct one or more image information towards the image entry surface; and
an optical image deflector unit comprising:
a first surface and a second surface, wherein the second surface is opposite to the first surface,
the first surface arranged to reflect the directed one or more image information towards a semi-reflective outcoupling surface, wherein an angle of incidence between the directed one or more image information and the first surface is higher than a first angle,
the semi-reflective outcoupling surface arranged between the first surface and the second surface to deflect the reflected one or more image information towards the first surface, wherein the angle of incidence between the deflected one or more image information and the first surface is lower than the first angle, and
the image entry surface arranged on an optical path between the image source and the semi-reflective outcoupling surface.

2. A display system according to claim 1, wherein the image source and the first optics are configured to generate images with multiple focal distances.

3. A display system according to claim 1, wherein the image source is a multi-focal image source.

4. A display system according to claim 3, wherein the multi-focal image source comprises an orthogonal prism arrangement comprising of at least two self-emissive micro-displays arranged on a common optical axis.

5. A display system according to claim 3, wherein the multi-focal image source comprises an image generator comprising rear image projection unit and a multi-layer optical chip configured to define physical display planes, wherein the multi-layer optical chip comprises at least two display layers.

6. A display system according to claim 5, wherein the multi-layer optical chip is an array of electrically driven fast-switching optical diffusers having binary optical states:
a first optical state comprising high light transmission, and
a second optical state comprising high haze values.

7. A display system according to claim 5, wherein thickness of the at least two display layers is in the range of 4-15 micrometres for each display layer and wherein the distance between each display layer is in the range of 80-450 micrometres.

8. A display system according to claim 5, wherein the image source further comprises a driving and processing unit communicably coupled to the optical chip and the image generator, wherein the driving and processing unit configured to:
drive the layers of optical chip one by one in a sequential or non-sequential manner from the first optical state to the second optical state,
to keep the selected layer of optical chip in the second optical state for a period of time equal or larger than 500 microseconds, and
to follow a switching from the second optical state to the first optical state.

9. A display system according to claim 1, wherein the optical image deflector unit is a transparent optical image deflector unit, which is transparent to visible part of the electromagnetic spectrum.

10. A display system according to claim 1, wherein the optical image deflector unit has a geometry, which is configured to limit reflections of one or more image information from the first surface to one reflection before reflecting from the semi-reflective outcoupling surface.

11. A display system according to claim 1, wherein at least one of the semi-reflective outcoupling surface, the image entry surface, the first surface, the second surface is selected from at least one of bi-conic surface an optical meta surface, a holographic optical element, a diffractive surface.

12. A display system according to claim 1, wherein the first surface and the second surface have equal curvatures.

13. A display system according to claim 1, wherein the optical image deflector unit has an index of refraction higher than 1.45.

14. A display system according to claim 1, wherein the first angle is a critical angle

15. A display system according to claim 1, wherein the angle of incidence which is higher than the first angle is between 45 and 85 degrees.

16. A display system according to claim 1, wherein the angle of incidence which is lower than the first angle is between 0 and 45 degrees.

17. A display system according to claim 1, wherein the first optics have a first focal length and the image source is arranged to be closer to the first optics than the first focal length.

18. A head mounted display system comprising a display system according to claim 1.

19. A method for generating 3D image, the method comprising:
generating one or more image information for a first focal distance with an image source;
directing the one or more image information towards an optical image deflector unit;
directing the one or more image information towards a first surface of the optical image deflector unit;
reflecting the one or more image information from the first surface towards a semi-reflective outcoupling surface of the optical image deflector unit; and
deflecting the one or more image information from the semi-reflective outcoupling surface towards the first surface of the optical image deflector unit.

20. A method according to claim 19, wherein the one or more image information is reflected from the first surface not more than one time before reaching the semi-reflective outcoupling surface.
